(19) United States
(12) Patent Application Publication
(10) Pub. No.: US 2014/0305382 A1
(43) Pub. Date: Oct. 16, 2014

(54) WIND MACHINE WITH PROPELLER MOUNTED BIRD REPELLENT STRIPS

(71) Applicant: ORACHARD-RITE LIMITED, INC., Yakima, WA (US)

(72) Inventor: Daryl G. Hill, Yakima, WA (US)

(21) Appl. No.: 14/253,820

(22) Filed: Apr. 15, 2014

Related U.S. Application Data
(60) Provisional application No. 61/812,145, filed on Apr. 15, 2013.

(51) Int. Cl. A01M 29/06

(52) U.S. Cl. CPC A01M 29/06
USPC 119/713

(57) ABSTRACT

A bird repellent system for a wind machine with propeller blades mounted to a propeller hub on a mast, each propeller blade having a propeller tip at a distal end of the propeller blade, and a bird repellant ribbon attached to the propeller tip, so rotation of the propeller blades generates a wind stream parallel to a ground surface, to impart an action to the bird repellant ribbon. The bird repellent ribbon can be made from a mylar type of plastic film, and have holographic reflective features. The propeller blades can also include one or more strips of a reflective material adhered to the propeller.

### CROSS-REFERENCE TO RELATED APPLICATION

This Non-Provisional Utility Patent Application claims the benefit of U.S. Provisional Application No. 61/812,145, filed Apr. 15, 2013.

### TECHNICAL FIELD

The invention relates to a bird repellent system employing a plurality of ribbon streamers attached to a propeller, and more particularly a system for the attachment of bird repellent strips to a propeller of a wind machine, or alternatively a wind-powered generator.

### BACKGROUND OF THE INVENTION

Birds are a common threat to fruit crops, especially berries, grapes and stone fruits. Typical bird repellants include mylar or other plastic ribbon hang from horizontal poles or tree branches. These conventional bird repellent ribbons rely on the wind or disturbance by the birds, to provide a bird repellant action. There is a need for better, more reliable and economical bird repellant system for crops that ideally employs equipment already present in the orchard, vineyard or farm.

The following is a disclosure of the present invention that will be understood by reference to the following detailed description taken in conjunction with the accompanying drawings.

### BRIEF DESCRIPTION OF DRAWINGS

FIG. 1 is a perspective view of a wind machine with propeller mounted bird repellent strips, according to an embodiment of the invention;

FIG. 2 is a perspective view of a portion of a wind machine with propeller mounted bird repellent strips, according to an embodiment of the invention; and

FIG. 3 is a front view of a wind machine with propeller mounted bird repellent strips, according to an embodiment of the invention.

### DETAILED DESCRIPTION OF SPECIFIC EMBODIMENTS

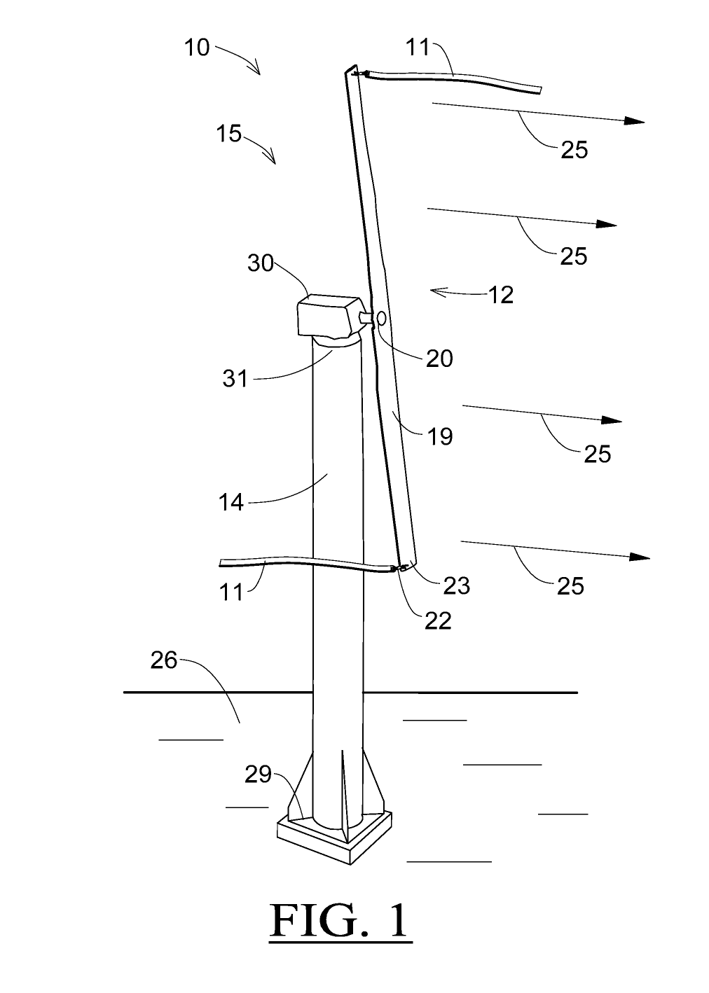

The invention relates to a bird repellent system employing a plurality of streamers or strips, attached to a propeller of a wind machine, or alternatively a wind powered generator, or a wind mill. FIGS. 1 through 3 show the bird repellent system 10, according to certain preferred embodiments of the present invention. The bird repellent system includes a bird repellant ribbon 11 attached to a propeller 12, which is mounted to a mast 14 of a wind machine 15.

Generally, wind machines 15 are increasingly employed for frost protection for agricultural applications, often to prevent springtime frost damage to a crop by circulating the air near the crop. In the wind machine, the propeller 12 rotates on the mast 14 to move warmer air aloft, and thereby raise the temperature of the air near the crop, on the ground below. The rotation of the propeller generates a wind stream 25, as shown in FIG. 1. For wind machines, the wind stream is parallel to the ground surface 26. Other applications of wind machine technology are observed in propeller driven crop cooling and drying systems, odor control machines, and windmills or wind power generation equipment, the common requirement that the rotation of the propeller generates a wind stream that is parallel to the ground surface.

By adding the bird repellent system 10 elements of the present invention, to a conventional wind machine, the wind machine 15 can serve the additional and novel function of repelling birds. An unforseen benefit in this unique combination of bird repellant and wind machine is realized in the concurrent operation of the wind machine to repel birds and prevent frost damage. Even when the propellers 12 of the wind machine are not rotating operationally, the bird repellent system continues to operate by passive action of sunlight and ambient breezes or wind.

Most typically, as shown in FIG. 1, the propeller 12 of the wind machine 15 has two propeller blades 19, each mounted opposed to the other on a propeller hub 20, to rotate about the hub. However, propellers with three, four or more blades can be employed. Each propeller blade includes a propeller tip 28 at its distal end, which is opposite to the propeller hub. The mast is conventionally mounted onto an anchor base 29, with the mast extending upward and having a propeller transmission 30 mounted at a top end 31 of the mast.

The bird repellant ribbon 11 is preferably a conventional bird deterrent strip or streamer, made from a Mylar type of plastic film. The strips flash and flutter in the sun with the aid of wind action, and are used to scare birds of all species. The strips are typically mirrored, reflective and optionally iridescent, or can include holographic reflective features. The typical use of such bird repellant strips simply includes their attachment to conventional devices, including tree limbs, trellises and suspended guide wires. The common feature of these conventional attachments is that they are dedicated to conventional bird repellent devices and not augmented to a wind machine 15.

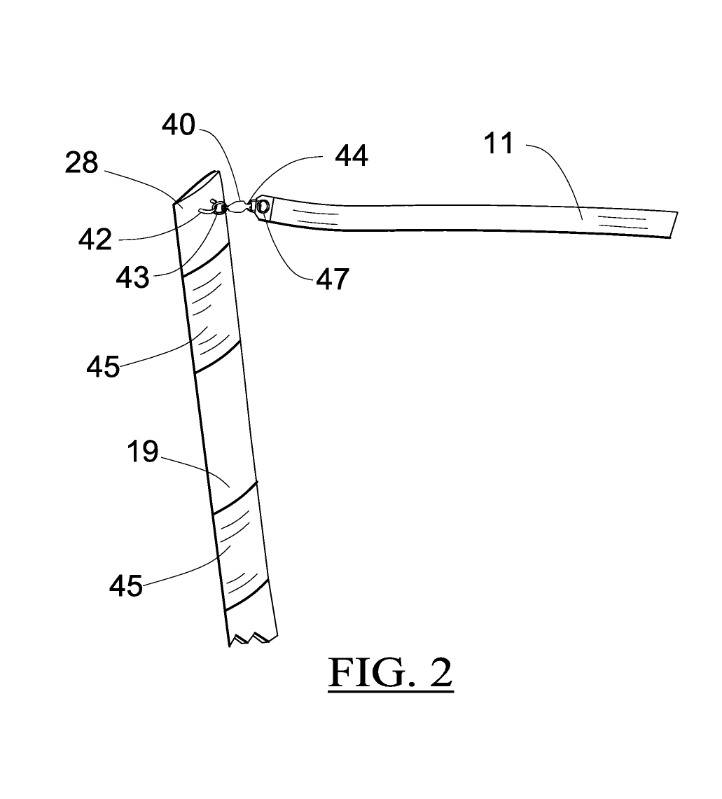

FIG. 2 details the bird repellant ribbon 11 attached to the propeller tip 28. The attachment can be any means as are known to those skilled in such technologies, and a preferred attachment includes a swivel 40 connecting the propeller 12 to the bird repellent ribbon. The swivel includes a first end 43 and a second end 44. The swivel can be any commercial or industrial type of swivel, and is preferably a heavy-duty, commercial fishing type of swivel, made of a stainless steel. Most preferably, a U-bolt 42 is mounted to the propeller tip 28, which receives a first end of the swivel, and the bird repellant ribbon includes a grommet 47, which receives a second end of the swivel.

Most preferably the bird repellant ribbon 11 is approximately two to three feet in length, and approximately to four inches in diameter. Mirror-reflective and durable Mylar type material is preferred for the bird repellant ribbon. However, any flexible and reasonably durable material may be employed as a possible alternative.

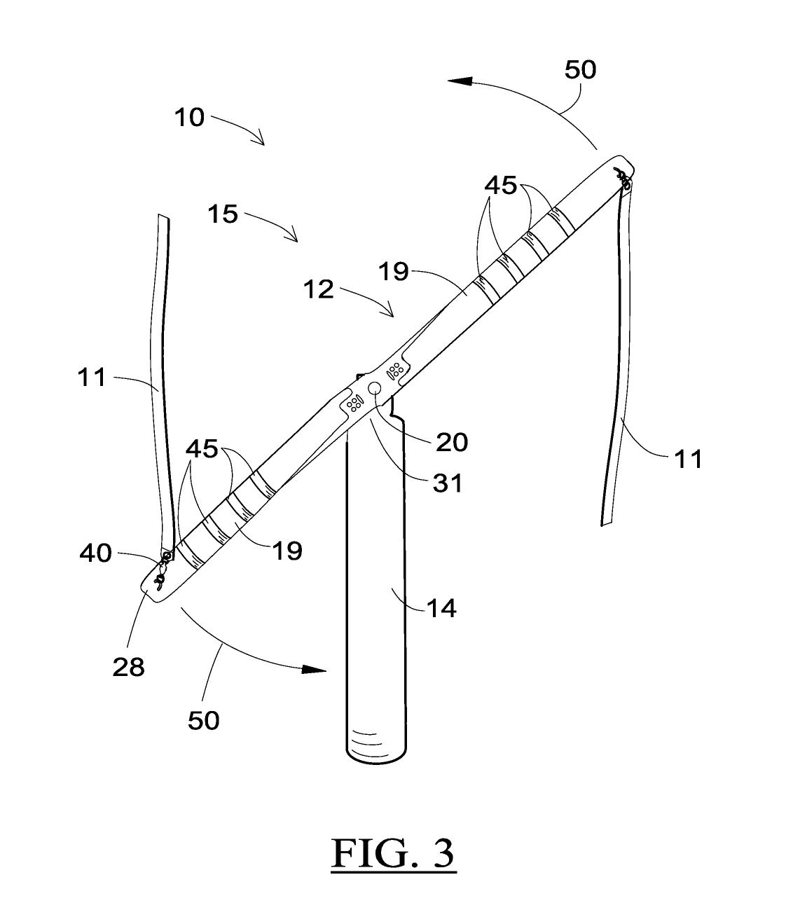

In the preferred embodiment of the propeller blades 19 of the wind machine 15 have a direction of rotation 50, as shown in FIG. 3, with the bird repellant ribbon 11 following the rotating propeller tip 28, to which it is attached. The wind stream 25 parallel to the ground surface 26, as shown in FIG. 1, also acts upon the rotating bird repellant ribbon, imparting a vigorous fluttering action to the bird repellant ribbon. Alternatively, if the force of the wind 16 spins the propeller 12, upon the propeller hub 20, the same rotation results and the bird repellant ribbon is similarly imparted with the vigorous fluttering action. Also alternatively, the propellers can additionally include a blade strip 45, of a reflective tape or shinny material, adhered to the propeller blades 19, as shown in FIGS. 2 and 3. These blade strips serve to increase the visual bird repellent action of the bird repellent system 10. As with the bird repellant ribbons, the blades strips can be mirrored, reflective, or alternatively iridescent or include holographic reflective features.

A method of the bird repellent system 10 for a wind machine 15 employs a plurality of bird repellant ribbon 11 streamers attached to the propeller 12 of the wind machine, Rotating the propeller tip 28, to which the bird repellant ribbon is attached imparts a vigorous fluttering action to the bird repellant ribbon. Additionally, adhering a blade strip 45 of a reflective tape or shinny material to the propeller blades 19, adds an additional repelling of birds.

In compliance with the statutes, the invention has been described in language more or less specific as to structural features and method steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

1. A method of a bird repellent system for a wind machine comprising the steps of:
a) attaching a plurality of ribbon streamers proximate to a propeller tip of a propeller of the wind machine;
b) rotating the propeller;
c) imparting a fluttering action to the plurality of ribbon streamers; and
d) repelling birds with the fluttering action of the plurality of ribbon streamers.

2. The method of a bird repellent system for a wind machine of claim 1 additionally including the steps of:
e) adhering a blade strip of a shinny material to a propeller blade of the propeller; and
f) further repelling birds with the shinny material on the rotating propeller.

3. A bird repellent system for a wind machine comprising:
a vertical propeller blade rotationally mounted to a propeller hub on a mast of a wind machine, the propeller blade having a propeller tip at a distal end of the propeller blade, the distal end opposite to the propeller hub, and the mast mounted onto an anchor base;
a bird repellant ribbon attached to the propeller tip; and
a rotation of the propeller blade generates a wind stream parallel to a ground surface, to impart an action to the bird repellant ribbon.

4. The bird repellent system of claim 3, wherein the bird repellant ribbon is made from a mylar type of plastic film.

5. The bird repellent of claim 3, wherein the bird repellant ribbon includes holographic reflective features.

6. The bird repellent of claim 3, wherein the propeller blade additionally includes a blade strip of a reflective material, the blade strip adhered to the propeller blade.

7. A bird repellent system for a wind machine comprising:
a propeller rotationally mounted to a mast of the wind machine, the propeller having a propeller tip;
a ribbon streamer attached proximate to the propeller tip; and
a rotation of the propeller to impart an action to the ribbon streamer.

8. The bird repellent system of claim 7, wherein the bird repellant ribbon includes a mylar type of plastic film.

9. The bird repellent system of claim 7, wherein the bird repellant ribbon includes a mylar type of plastic film.

10. The bird repellent of claim 7, wherein the bird repellant ribbon includes a holographic reflective feature.

11. The bird repellent of claim 7, wherein the propeller blade additionally includes a blade strip of a reflective material, the blade strip adhered to the propeller blade.
